(19) United States
(12) Patent Application Publication
(10) Pub. No.: US 2024/0411845 A1
(43) Pub. Date: Dec. 12, 2024

(54) LOAD SPECIFICATION DEVICE, LOAD SPECIFICATION METHOD, AND COMPUTER READABLE MEDIUM

(71) Applicant: MITSUBISHI ELECTRIC CORPORATION, Tokyo (JP)

(72) Inventor: Masahiro FUJITA, Tokyo (JP)

(73) Assignee: MITSUBISHI ELECTRIC CORPORATION, Tokyo (JP)

(21) Appl. No.: 18/756,521

(22) Filed: Jun. 27, 2024

Related U.S. Application Data
(63) Continuation of application No. PCT/JP2022/005322, filed on Feb. 10, 2022.

(51) Int. Cl. G06F 21/31; G06F 21/45

(52) U.S. Cl. CPC G06F 21/31; G06F 21/45

(57) ABSTRACT

A load specification device (10) specifies a load of two-factor authentication in which a first authentication and a second authentication are performed in order. A first load specification unit (22) specifies a first authentication load being a load of a user to perform the first authentication. A second load specification unit (23) specifies a second authentication load being a load of the user to perform the second authentication. A connection load specification unit (24) specifies a connection load being a load of the user with respect to an operation to transition from the first authentication to the second authentication. A load integration unit (25) integrates the first authentication load, the second authentication load and the connection load, and specifies the load of two-factor authentication.

### CROSS REFERENCE TO RELATED APPLICATION

This application is a Continuation of PCT International Application No. PCT/JP2022/005322, filed on Feb. 10, 2022, which is hereby expressly incorporated by reference into the present application.

### TECHNICAL FIELD

The present disclosure relates to a load evaluation technique of a user in two-factor authentication.

### BACKGROUND ART

In many authentication systems, a single user authentication method is adopted. As a concrete example, only an authentication method of any one of password authentication, PIN authentication and fingerprint authentication is adopted. PIN is an abbreviation for Personal Identification Number. Hereinafter, a user authentication method is simply called an authentication method.

As a method to improve security of an authentication system, there exists a method to introduce two-factor authentication combining two types of authentication methods. For example, there exist combinations of authentication methods such as password authentication+PIN authentication, password authentication+fingerprint authentication, and password authentication+device authentication.

When two-factor authentication is adopted, a load of a user is increased in comparison with a case of adopting a single authentication method. Therefore, it is necessary to adopt a combination of authentication methods which minimizes the load of the user as much as possible.

There is disclosed in Patent Literature 1 to present a plurality of combinations of authentication methods to a user, and to let the user select a combination of authentication methods with a load that the user perceives as the smallest.

### CITATION LIST

### Patent Literature

Patent Literature 1: JP 2016-45811 A

### SUMMARY OF INVENTION

### Technical Problem

There are implementation forms as much as the number of combinations of authentication methods in two-factor authentication. In introducing two-factor authentication, it is desirable to quantitatively evaluate how much the load of a user increases, and to adopt a combination of authentication methods that minimizes the load of the user as much as possible, with respect to each combination. However, in Patent Literature 1, it is not considered quantitative evaluation of the load of the user generated in two-factor authentication.

The present disclosure is aimed at making it possible to appropriately evaluate the load of the user in two-factor authentication.

### Solution to Problem

A load specification device according to the present disclosure is a load specification device to specify a load of a two-factor authentication in which a first authentication and a second authentication are performed in order, the load specification device including
a first load specification unit to specify a first authentication load being a load of
a user to perform the first authentication;
a second load specification unit to specify a second authentication load being a load of the user to perform the second authentication;
a connection load specification unit to specify a connection load being a load of the user with respect to an operation to transition from the first authentication to the second authentication, and
a load integration unit to integrate the first authentication load, the second authentication load and the connection load, and specify the load of the two-factor authentication.

### Advantageous Effects of Invention

In the present disclosure, a load of two-factor authentication is specified by integrating each load of first authentication and second authentication, and a load with respect to an operation of transition from the first authentication to the second authentication. In this manner, it is possible to properly evaluate the load of two-factor authentication.

### BRIEF DESCRIPTION OF DRAWINGS

FIG. 1 is a configuration diagram of a load specification device 10 according to a first embodiment;

FIG. 2 is a flowchart illustrating a flow of an operation of the load specification device 10 according to the first embodiment;

FIG. 3 is an explanatory drawing of authentication load information 31 according to the first embodiment;

FIG. 4 is an explanatory drawing of connection load information 32 according to the first embodiment;

FIG. 5 is a configuration diagram of the load specification device 10 according to a first variation;

FIG. 6 is a configuration diagram of the load specification device 10 according to a second embodiment;

FIG. 7 is a flowchart illustrating a flow of an operation of the load specification device 10 according to the second embodiment;

FIG. 8 is an explanatory drawing of a second calculation method 33 according to the second embodiment;

FIG. 9 is an explanatory drawing of a connection calculation method 34 according to the second embodiment;

FIG. 10 is a configuration diagram of the load specification device 10 according to a third embodiment;

FIG. 11 is a flowchart illustrating a flow of an operation of the load specification device 10 according to the third embodiment;

FIG. 12 is an explanatory drawing of a first authentication log 35 according to the third embodiment;

FIG. 13 is a configuration diagram of the load specification device 10 according to a fourth embodiment

FIG. 14 is a flowchart illustrating a flow of an operation of the load specification device 10 according to the fourth embodiment; and

FIG. 15 is an explanatory diagram of psychological load information 36 according to the fourth embodiment.

### DESCRIPTION OF EMBODIMENTS

### First Embodiment

### Description of Configuration

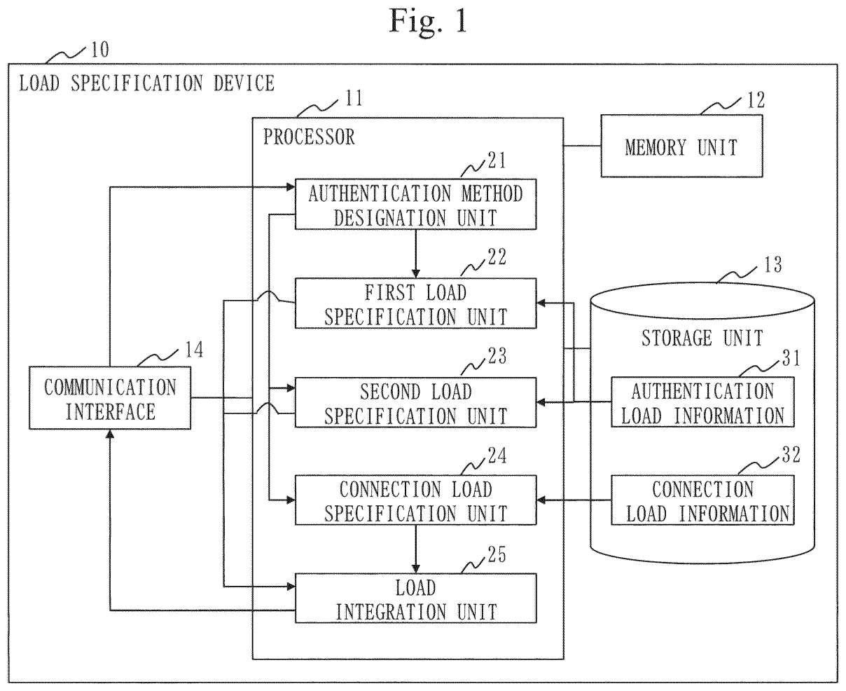

Description will be made on a configuration of a load specification device 10 according to a first embodiment with reference to FIG. 1.

The load specification device 10 is a computer.

The load specification device 10 includes hardware components of a processor 11, a memory unit 12, a storage unit 13 and a communication interface 14. The processor 11 is connected to the other hardware components via signal lines, and controls these other hardware components.

The processor 11 is an IC to perform processing. IC is an abbreviation for Integrated Circuit. The processor 11 is, for example, a CPU, a DSP or a GPU. CPU is an abbreviation for Central Processing Unit. DSP is an abbreviation for Digital Signal Processor. GPU is an abbreviation for Graphics Processing Unit.

The memory unit 12 is a storage device to temporarily store data. The memory unit 12 is, for example, an SRAM or a DRAM. SRAM is an abbreviation for Static Random Access Memory. DRAM is an abbreviation for Dynamic Random Access Memory.

The storage unit 13 is a storage device to store data. The storage unit 13 is, for example, an HDD. HDD is an abbreviation for Hard Disk Drive. Further, the storage unit 13 may be a portable recording medium such as an SD (registered trademark) memory card, a CompactFlash (registered trademark), a NAND Flash memory, a flexible disk, an optical disk, a compact disk, a Blue-ray (registered trademark) disk, a DVD or the like. SD is an abbreviation for Secure Digital. DVD is an abbreviation for Digital Versatile Disk.

The communication interface 14 is an interface to communicate with an external device. The communication interface 14 is, for example, a port of an Ethernet (registered trademark), a USB or an HDMI (registered trademark). USB is an abbreviation for Universal Serial Bus. HDMI is an abbreviation for High-Definition Multimedia Interface.

The load specification device 10 includes an authentication method designation unit 21, a first load specification unit 22, a second load specification unit 23, a connection load specification unit 24 and a load integration unit 25, as functional components. The functions of each functional component of the load specification device 10 are realized by software.

The storage unit 13 stores programs to realize the functions of each functional component of the load specification device 10. These programs are read into the memory unit 12 by the processor 11, and executed by the processor 11. In this manner, the functions of each functional component of the load specification device 10 are realized.

The storage unit 13 stores authentication load information 31 and connection load information 32.

In FIG. 1, only one processor 11 is illustrated. However, there may be a plurality of processors 11, and the plurality of processors 11 may execute the programs to realize each function in cooperation with one another.

### Description of Operation

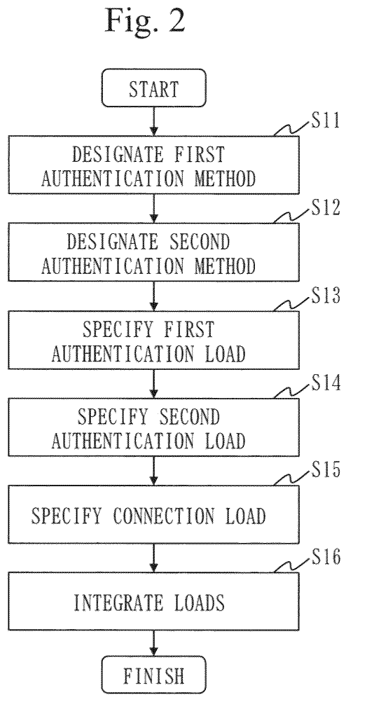

Description will be made on an operation of the load specification device 10 according to First Embodiment with reference to FIG. 2 through FIG. 4.

The operation procedure of the load specification device 10 according to First Embodiment corresponds to a load specification method according to First Embodiment. Further, the programs to realize the operation of the load specification device 10 according to First Embodiment correspond to a load specification program according to First Embodiment.

Two authentication methods used in two-factor authentication are called first authentication and second authentication. The first authentication and the second authentication are sequentially implemented. It is assumed here that the second authentication shall be implemented after the first authentication.

The operation that is necessary from the start to the end of the first authentication is called a first authentication operation. The operation from the start to the end of the second authentication is called a second authentication operation. The operation to transition from the first authentication to the second authentication is called an authentication connection operation.

Description will be made on a concrete example of each operation by assuming that the first authentication shall be password authentication, and the second authentication shall be fingerprint authentication.

The password authentication and the fingerprint authentication are authentication devices independent of each other. In the password authentication, a “password authentication start” button and a “password authentication completion” button are assumed to be placed. In the fingerprint authentication, a “fingerprint authentication start” button and a “fingerprint authentication completion” button are assumed to be placed. When both authentications are completed, two-factor authentication is assumed to be completed.

That is, in the password authentication, after the “password authentication start” button is pressed, a password is input from a password input device, the “password authentication completion” button is pressed, and authentication is completed. In the fingerprint authentication, after the “fingerprint authentication start” button is pressed, a fingerprint is input via a fingerprint input device, the “fingerprint authentication completion” is pressed, and authentication is completed. The first authentication operation is an operation of a user that is necessary from

the operation to press the “password authentication start” button until the operation to press the “password authentication completion” button. The second authentication operation is an operation of a user that is necessary from the operation to press the “fingerprint authentication start” button until the operation to press the “fingerprint authentication completion” button.

The authentication connection operation is an operation that is necessary after the operation to press the “password authentication completion” button and before the operation to press the “fingerprint authentication start” button. The password authentication and the fingerprint authentication are authentication devices independent of each other. Therefore, an operation to move a hand or consciousness, etc. in order to change an operation target is necessary. The authentication connection operation includes this type of operation.

The load of the user generated by performing the first authentication operation by the user is called a first authentication load. The load of the user generated by performing the second authentication operation by the user is called a second authentication load. The load of the user generated by performing the authentication connection operation by the user is called a connection load. The load of the user represents convenience of the user. The higher the load is, the lower the convenience is.

Description will be made on a concrete example of each load using the concrete example as described above. The first authentication load is a load of the user generated from the time when the “password authentication start” button is pressed until the time when the “password authentication completion” button is pressed. The second authentication load is a load of the user generated from the time when the “fingerprint authentication start” button is pressed until the time when the “fingerprint authentication completion” button is pressed. The connection load is a load generated from the time when the “password authentication completion” button is pressed until the time when the “fingerprint authentication completion” button is pressed.

The load of the user may be an arbitrary index as long as it quantitatively represents the load generated at the time the user performs each operation. For example, the loads of the user are indexes such as an operation time, a value of usability evaluated by the user in five levels, and a possibility of failure of the operation. Otherwise, the load of the user may be an index that can be calculated by a rule or a calculation formula, by defining the rule or the calculation formula beforehand. The rule may be “1 point if the operation time is one second or longer; if not, 0 point”. The calculation formula may be “operation time×0.5”. Further, the rule or the calculation formula may be based on another authentication load such as “connection load=first authentication load×2”.

The same or different index may be used for the first authentication load, the second authentication load and the connection load.

Description will be made on a flow of an operation of the load specification device 10 according to First Embodiment, with reference to FIG. 2.

### (Step S11: First Designation Process)

The authentication method designation unit 21 accepts designation of the first authentication method being an authentication method used in the first authentication. Specifically, the authentication method designation unit 21 accepts designation of a name or the like to identify the first authentication method, from the user via an input device.

The name is a character string such as password authentication, PIN authentication and fingerprint authentication. Not just the name, but other information may be designated as long as the authentication method can be specified. Herein, it is assumed that “password authentication” is designated as the first authentication method.

### (Step S12: Second Designation Process)

The authentication method designation unit 21 accepts designation of the second authentication method being an authentication method used in the second authentication. Specifically, the authentication method designation unit 21 accepts designation of a name or the like to identify the second authentication method, from the user via an input device, as in Step S11. Herein, it is assumed that “fingerprint authentication” is designated as the second authentication method.

### (Step S13: First Load Specification Process)

The first load specification unit 22 specifies a first authentication load being a load of a user to perform the first authentication. Specifically, the first load specification unit 22 specifies the load with respect to the first authentication method accepted in Step S11 as the first authentication load.

In First Embodiment, the first load specification unit 22 reads out a load corresponding to the first authentication method used in the first authentication, from the authentication load information 31 in which a load for each authentication method is stored. The first load specification unit 22 specifies the load read out as the first authentication load.

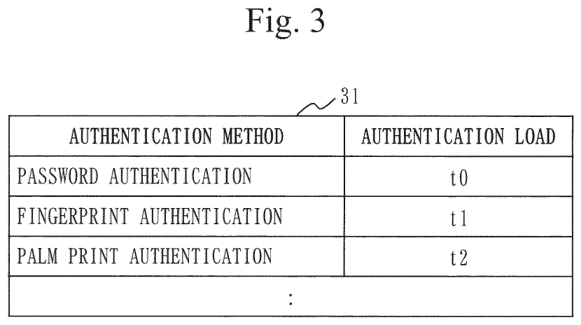

As illustrated in FIG. 3, it is assumed that the authentication load information 31 is set. In FIG. 3, an operation time is stored as a load for each name of the authentication method. In this case, the first load specification unit 22 searches a row of name in the authentication load information 31 by using “password authentication” accepted in Step S11 as a key, and reads out a value set in the row of load. In this manner, the first load specification unit 22 specifies an operation time to being a load corresponding to “password authentication” as the first authentication load.

### (Step S14: Second Load Specification Process)

The second load specification unit 23 specifies a second authentication load being a load of the user to perform the second authentication. Specifically, the second load specification unit 23 specifies the load with respect to the second authentication method accepted in Step S12 as the second authentication load.

In First Embodiment, the second load specification unit 23 reads out a load corresponding to the second authentication method used in the second authentication, from the authentication load information 31 in which a load for each authentication method is stored. The second load specification unit 23 specifies the load read out as the second authentication load.

As illustrated in FIG. 3, the authentication load information 31 shall be set. In this case, the second load specification unit 23 searches a row of name in the authentication load information 31 by using “fingerprint authentication” accepted in Step S12 as a key, and reads out a value set in the row of load. In this manner, the second load specification unit 23 specifies an operation time tl being a load corresponding to “fingerprint authentication” as the second authentication load.

### (Step S15: Connection Load Specification Process)

The connection load specification unit 24 specifies a connection load being a load of the user with respect to an operation to transition from the first authentication to the second authentication. Specifically, the connection load specification unit 24 specifies the connection load with respect to the operation to transition from the first authentication method accepted in Step S11 to the second authentication method accepted in Step S12.

In First Embodiment, the connection load specification unit 24 reads out a load corresponding to a combination of the first authentication method used in the first authentication and the second authentication method used in the second authentication, from the connection load information 32 in which a load for each combination of authentication methods is stored. The connection load specification unit 24 specifies the load read out as the connection load.

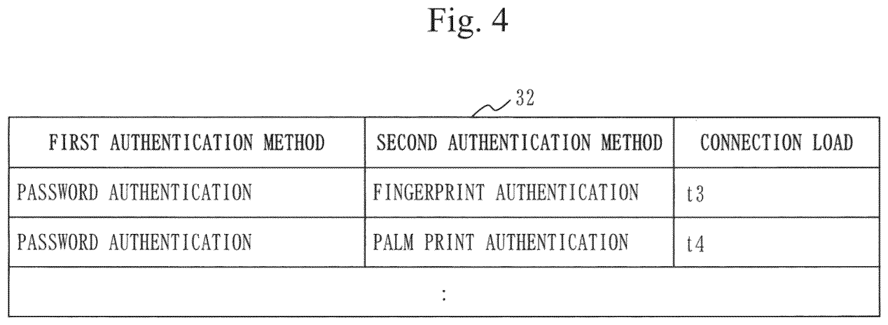

The connection load information 32 is assumed to be set as illustrated in FIG. 4. In FIG. 4, an operation time is stored as the load for each combination of names of two authentication methods. In this case, by using a combination of “password authentication” accepted in Step S11 and “fingerprint authentication” accepted in Step S12 as a key, the connection load specification unit 24 searches a row of name in the connection load information 32, and reads out a value set in the row of load. In this manner, the connection load specification unit 24 specifies an operation time t3 being a load corresponding to the combination of “password authentication” being the first authentication method, and “fingerprint authentication” being the second authentication method, as the connection load.

### (Step S16: Load Integration Process)

The load integration unit 25 integrates the first authentication load specified in Step S13, the second authentication load specified in Step S14, and the connection load specified in Step S15, and specifies a load of two-factor authentication.

The load integration unit 25 is capable of using an arbitrary method as the integration method. Specifically, the load integration unit 25 is capable of integrating the first authentication load, the second authentication load and the connection load, by calculating the sum of the first authentication load, the second authentication load and the connection load. In this case, the load integration unit 25 specifies the operation time to+the operation time t1+the operation time t3 as the load of two-factor authentication.

The load integration unit 25 may integrate the first authentication load, the second authentication load and the connection load by calculating the sum after weighting the first authentication load, the second authentication load and the connection load. For example, it may be considered that the load integration unit 25 calculates “first authentication load+second authentication load×0.5+connection load”.

Further, the load integration unit 25 may define a rule, and integrate the first authentication load, the second authentication load and the connection load by the rule. For example, it may be possible to consider that the load integration unit 25 uses a rule such that “if all of the first authentication load, the second authentication load and the connection load are equal to or larger than X, the load of the user in two-factor authentication shall be α. If not, the load of the user in two-factor authentication shall be β.”

### Effect of First Embodiment

As described above, the load specification device 10 according to First Embodiment specifies the load of two-factor authentication by integrating each load of the first authentication and the second authentication, and a load with respect to the operation to transition from the first authentication to the second authentication. In this manner, it is possible to evaluate the load of two-factor authentication appropriately.

### Other Configurations

### <First Variation>

In First Embodiment, each functional component is realized by software. However, as First Variation, each functional component may be realized by a hardware component. With respect to First Variation, description will be made on different points from First Embodiment.

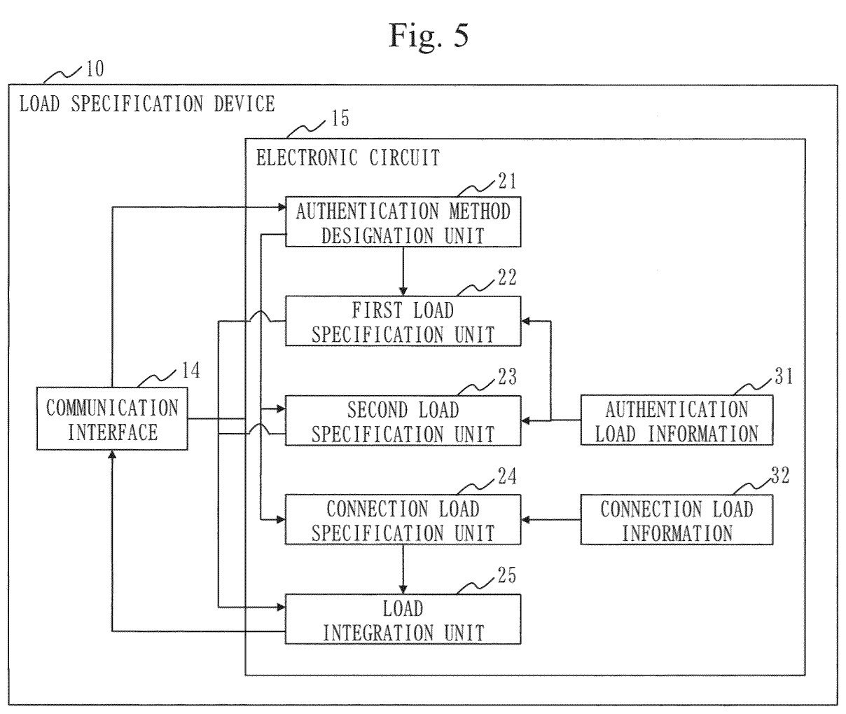

Description will be made on a configuration of the load specification device 10 according to First Variation with reference to FIG. 5.

When each functional component is realized by a hardware component, the load specification device 10 includes an electronic circuit 15 instead of the processor 11, the memory unit 12 and the storage unit 13. The electronic circuit 15 is a dedicated circuit to realize each functional component, and the functions of the memory unit 12 and the storage unit 13.

As the electronic circuit, a single circuit, a composite circuit, a processor made into a program, a processor made into a parallel program, a logic IC, a GA, an ASIC or an FPGA is supposed. GA is an abbreviation for “Gate Array”. ASIC is an abbreviation for “Application Specific Integrated Circuit”. FPGA is an abbreviation for “Field-Programmable Gate Array”.

Each functional component may be realized by one electronic circuit 15, or may be realized by a plurality of electronic circuits 15 dispersedly.

### <Second Variation>

As Second Variation, a part of each functional component may be realized by hardware components, and another part of each functional component may be realized by software.

The processor 11, the memory unit 12, the storage unit 13 and the electronic

circuit 15 are called processing circuitry. That is, the functions of each functional component are realized by processing circuitry.

### Second Embodiment

Second Embodiment is different from First Embodiment in that a second authentication load and a connection load are calculated from a first authentication load.

In Second Embodiment, description will be made on this different part, and description on the same parts will be omitted.

### Description of Configuration

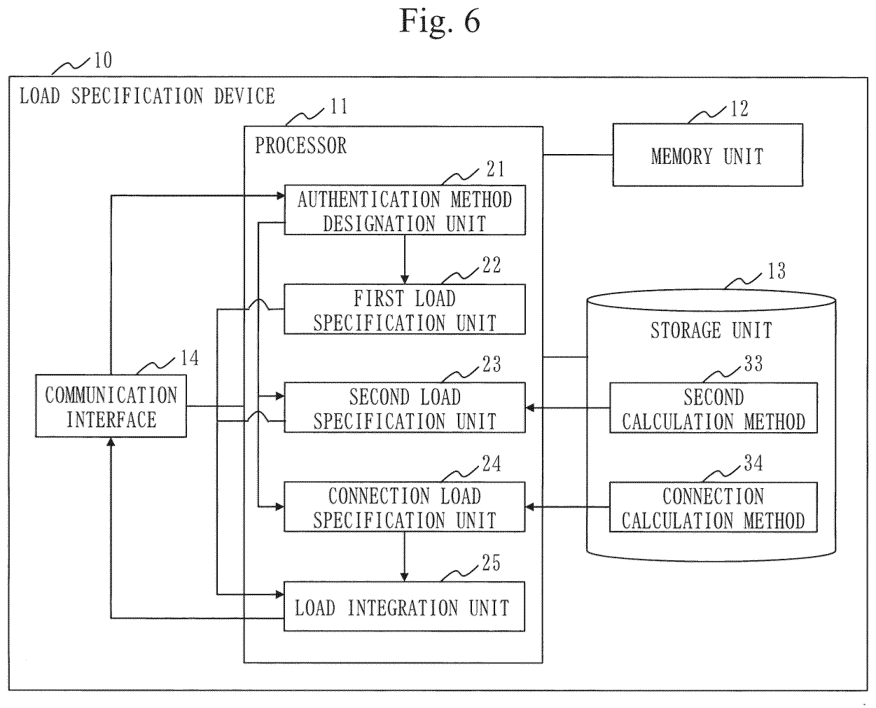

Description will be made on a configuration of the load specification device 10 according to Second Embodiment with reference to FIG. 6.

The load specification device 10 is different from the load specification device 10 illustrated in FIG. 1 in that the storage unit 13 stores a second calculation method 33 and a connection calculation method 34 instead of the authentication load information 31 and the connection load information 32. The second calculation method 33 indicates a method to calculate the second authentication load based on the first authentication load. The connection calculation method 34 indicates a method to calculate the connection load based on the first authentication load.

### Description of Operation*

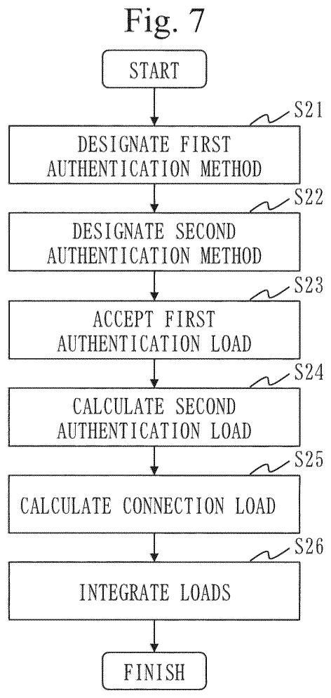

Description will be made on an operation of the load specification device 10 according to Second Embodiment with reference to FIG. 7 through FIG. 9.

The operation procedure of the load specification device 10 according to Second Embodiment corresponds to a load specification method according to Secon Embodiment. Further, a program to realize the operation of the load specification device 10 according to Second Embodiment corresponds to a load specification program according to Second Embodiment.

Description will be made on a flow of the operation of the load specification device 10 according to Second Embodiment with reference to FIG. 7.

The process from Step S21 to Step S22 are the same as the process from Step S11 to Step S12 in FIG. 2. The process of Step S26 is the same as the process of Step S16 in FIG. 2.

### (Step S23: First Load Specification Process)

The first load specification unit 22 specifies a first authentication load being a load of a user performing the first authentication.

In Second Embodiment, the first load specification unit 22 specifies a load designated, as the first authentication load. Specifically, the first load specification unit 22 accepts designation of a load from the user via an input device. It is assumed that an operation time is used as an index of the load. Herein, an operation time to is assumed to be designated.

### (Step S24: Second Load Specification Process)

The second load specification unit 23 specifies a second authentication load being a load of the user performing the second authentication.

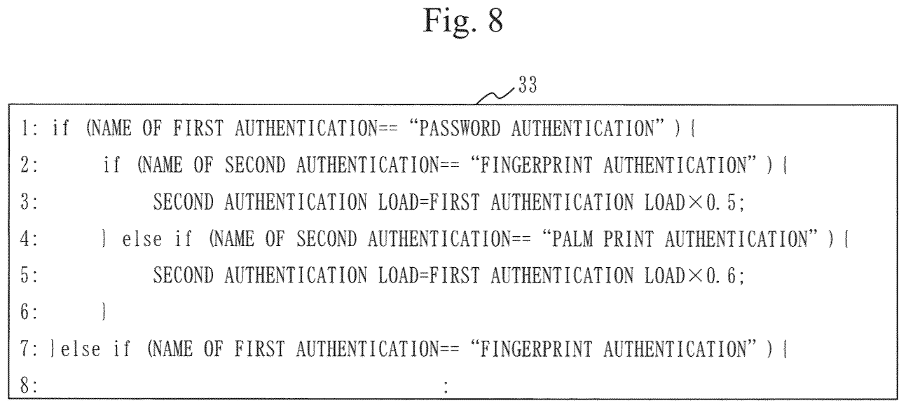

In Second Embodiment, the second load specification unit 23 calculates the second authentication load in accordance with a second calculation method 33. As illustrated in FIG. 8, the second calculation method 33 indicates a calculation method in accordance with a combination of the first authentication method used in the first authentication and the second authentication method used in the second authentication. The second calculation method 33 indicates a method to calculate the second authentication load based on the first authentication load. The second load specification unit 23 calculates the second authentication load based on the first authentication load by using a calculation method corresponding to the combination of the first authentication method and the second authentication method.

In this case, the second load specification unit 23 specifies “second authentication load=first authentication load×0.5” being the calculation method corresponding to “password authentication” being the first authentication method and “fingerprint authentication” being the second authentication method. The second load specification unit 23 calculates the second authentication load by substituting the first authentication load in the calculation method specified. As a result, in this example, the operation time t0×0.5 is specified as the second authentication load.

### (Step S25: Connection Load Specification Process)

The connection load specification unit 24 specifies a connection load being a load of the user with respect to an operation to transition from the first authentication to the second authentication.

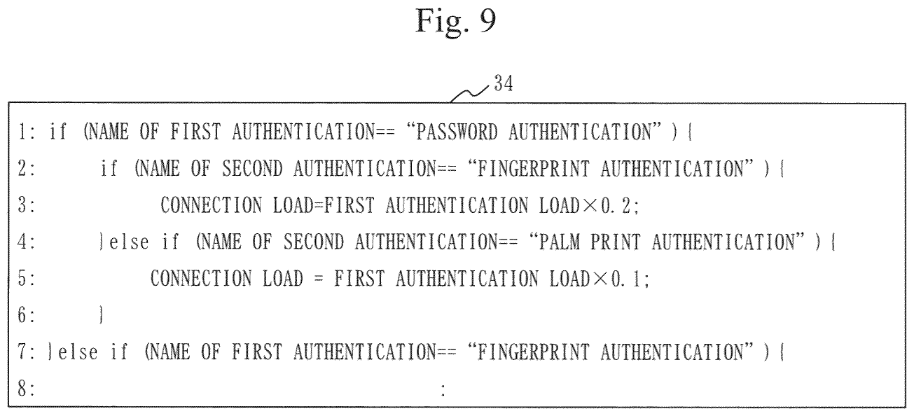

In Second Embodiment, the connection load specification unit 24 calculates the connection load in accordance with the connection calculation method 34. As illustrated in FIG. 9, the connection calculation method 34 indicates a calculation method in accordance with the combination of the first authentication method used in the first authentication and the second authentication method used in the second authentication. The connection calculation method 34 indicates a method to calculate the connection load based on the first authentication load. The connection load specification unit 24 calculates the connection load based on the first authentication load by using the calculation method corresponding to the combination of the first authentication method and the second authentication method.

In this case, the connection load specification unit 24 specifies “connection load =first authentication load×0.2” being a calculation method corresponding to a combination of “password authentication” being the first authentication method and “fingerprint authentication” being the second authentication method. The connection load specification unit 24 calculates the connection load by substituting the first authentication load in the calculation method specified. As a result, in this example, the operation time t0×0.2 is specified as the connection load.

The calculation methods illustrated in FIG. 8 and FIG. 9 are examples. Therefore, another method can be adopted as the calculation method. For example, the calculation method of the second authentication load may be a rule such that “if the first authentication load is a or larger, the second authentication load shall be. If not, the second authentication load shall be γ”. The same applies to the calculation method of the connection load.

As a result of the above, in Step S26, the load integration unit 25 specifies “operation time t0+operation time t0×0.5 +operation time t0×0.2” as the load of two-factor authentication.

### Effect of Second Embodiment

As described above, the load specification device 10 according to Second

Embodiment calculates the second authentication load and the connection load based on the first authentication load. In this manner, by specifying only the first authentication load precisely, the second authentication load and the connection load can be specified precisely.

### Another Configuration

### <Third Variation>

In Second Embodiment, the second authentication load and the connection load are specified based on the first authentication load. However, either one of the second authentication load and the connection load may be specified based on the first authentication load. The other may be specified by the method described in First Embodiment or the like.

### Third Embodiment

Third Embodiment is different from First and Second Embodiments in that the first authentication load is calculated from log data of a result of the first authentication method. In Third Embodiment, description will be made on this different point, and description on the same points will be omitted.

In Third Embodiment, description will be made on a case where a change is made to Second Embodiment. However, it is also possible to make a change to First Embodiment. There exists a case in which an authentication system using a single

authentication method is modified to make an authentication system of two-factor authentication. That is, there exists a case in which a second authentication is added to an authentication system where a first authentication has already been implemented. In this case, the first authentication method has already been implemented, and has been operated. Therefore, log data as a result of using the first authentication method has been accumulated. In Third Embodiment, the first authentication load is calculated using this log data.

### Description of Configuration

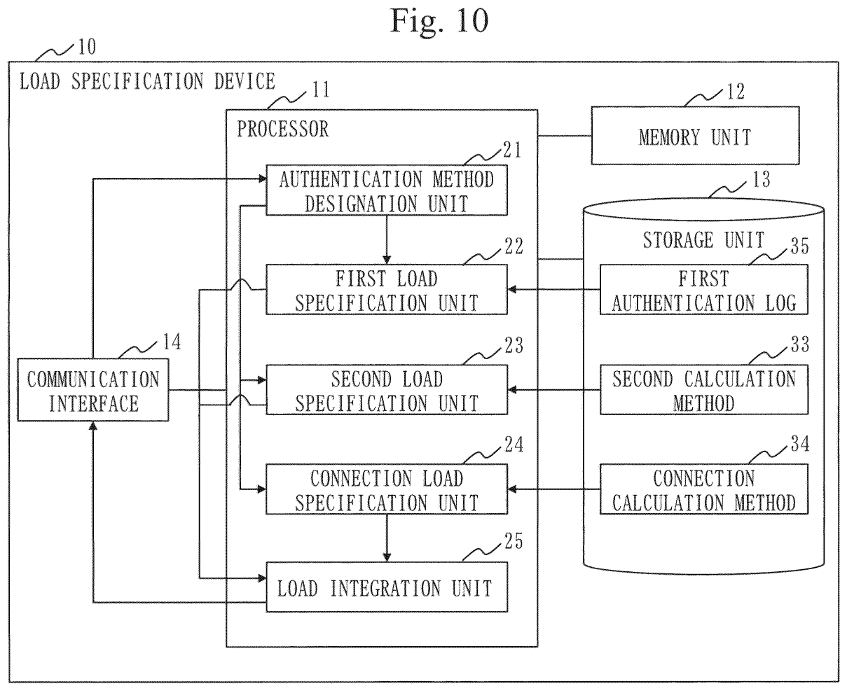

Description will be made on a configuration of the load specification device 10 according to Third Embodiment with reference to FIG. 10.

The load specification device 10 is different from the load specification device 10 illustrated in FIG. 6 in that the first authentication log 35 is stored in the storage unit 13. The first authentication log 35 is log data as a result of performing the first authentication method.

### Description of Operation

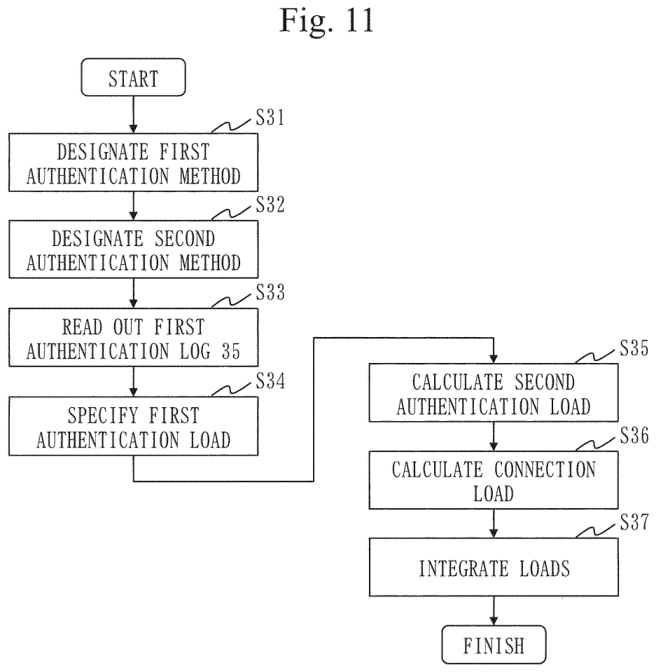

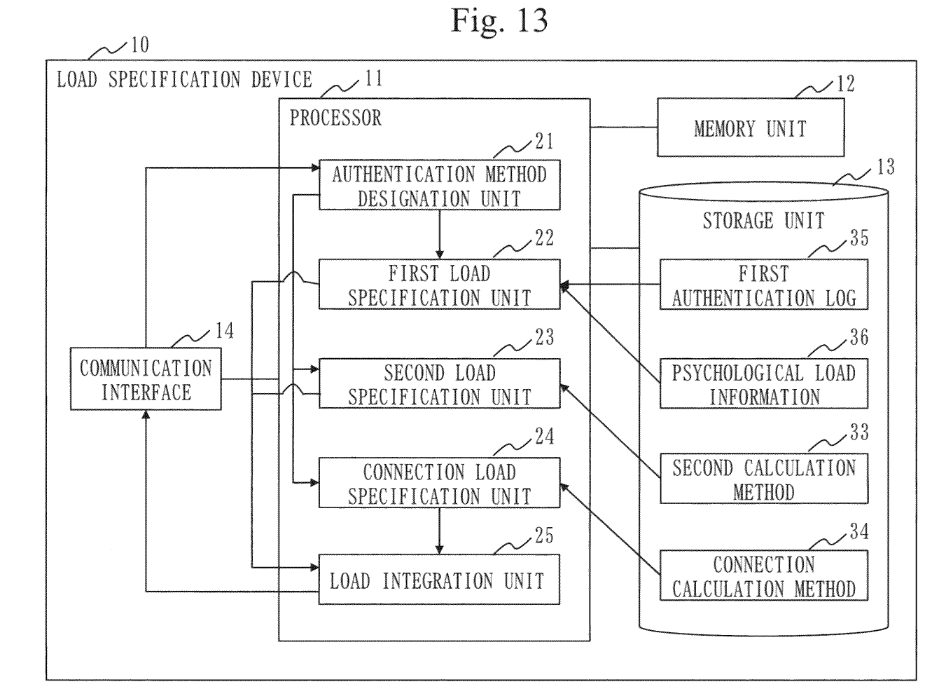

Description will be made on an operation of the load specification device 10 according to Third Embodiment, with reference to FIG. 11 and FIG. 13.

The operation procedure of the load specification device 10 according to Third Embodiment corresponds to a load specification method according to Third Embodiment. Further, a program to realize the operation of the load specification device 10 according to Third Embodiment corresponds to a load specification program according to Third Embodiment.

Description will be made on a flow of the operation of the load specification device 10 according to Third Embodiment, with reference to FIG. 11.

The process from Step S31 to Step S32 is the same as that from Step S21 to Step S22 in FIG. 7. The process from Step S35 through Step S37 is the same as that from Step S24 through Step S26 in FIG. 7.

### (Step S33: Log Readout Process)

The first load specification unit 22 reads out the first authentication log 35 from the storage unit 13.

The first authentication log 35 is data to record each item with respect to a state in which authentication is performed every time a user performs authentication on the authentication system. The item is information related to an authentication operation of a user that can be obtained by the system. For example, items are an operation time, whether successful or not, a date and time, a name of a user who has made a trial, and the like. Each record may include a plurality of items.

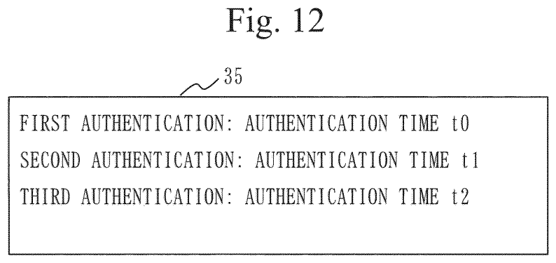

In this case, as illustrated in FIG. 12, the first authentication log 35 is assumed to be data recording an operation time as an item. In FIG. 12, it is recorded that it took an operation time to in the first authentication, an operation time tl in the second authentication, and an operation time t2 in the third authentication, for a certain user.

### (Step S34: First Load Specification Process)

The first load specification unit 22 specifies the first authentication load being a load of a user performing the first authentication.

In Third Embodiment, the first load specification unit 22 specifies the first authentication load from the first authentication log 35 read out in Step S33. It is possible for the first load specification unit to use an arbitrary method as a method to specify the first authentication load from the first authentication log 35. For example, the first load specification unit 22 is capable of specifying the mean value of every operation time indicated in the first authentication log 35 as the first authentication load.

In this case, the first load specification unit 22 specifies (t0+t1+t2)/3 as the first authentication load from the first authentication log 35 indicated in FIG. 12. That is, when each operation time is t0, t1, . . . , tn−1, (t0+t1+ . . . +tn−1)/n is specified as the first authentication load.

The first load specification unit 22 may specify the weighted average of every operation time indicated in the first authentication log 35 as the first authentication load. Further, the first load specification unit 22 may define a rule, and specify the first authentication load by the rule. For example, it may be considered that the first load specification unit 22 uses a rule such that “if the first authentication method is password authentication, and if it has been recorded that it takes T0 or longer as the operation time for X times or more, the first authentication load shall be α; if not, the first authentication load shall be β”.

Further, it may be considered that each record of the first authentication log 35 includes identification information of a user who has made a trial as an item. In this case, the first load specification unit 22 may specify the first authentication load by using only a record of a specific user.

### Effect of Third Embodiment

As described above, the load specification device 10 according to Third Embodiment calculates the first authentication load from log data as a result of performing the first authentication method. In this manner, it is possible to precisely specify a practical first authentication load.

Further, by using the method described in Third Embodiment in combination with the method described in Second Embodiment, it is possible to specify a practical value for the second authentication load and the connection load.

### Fourth Embodiment

Fourth Embodiment is different from First through Third Embodiments in that the first authentication load is calculated in consideration of a psychological load of a user. In Fourth Embodiment, description will be made on this different point, and description on the same points will be omitted.

In Fourth Embodiment, description will be made on a case where a change is made to Third Embodiment. However, it is possible to make a change to First and Second Embodiments.

The psychological load of the user is, for example, whether the user regards that the first authentication method is easy to use, whether the user wants to use the first authentication method, whether the first authentication method is perceived by the user positively, or the like.

### Description of Configuration

Description will be made on a configuration of the load specification device 10 according to Fourth Embodiment, with reference to FIG. 13.

The load specification device 10 is different from the load specification device 10 illustrated in FIG. 10 in that psychological load information 36 is stored in the storage unit 13. The psychological load information 36 is information quantitively representing the psychological load.

### Description of Operation

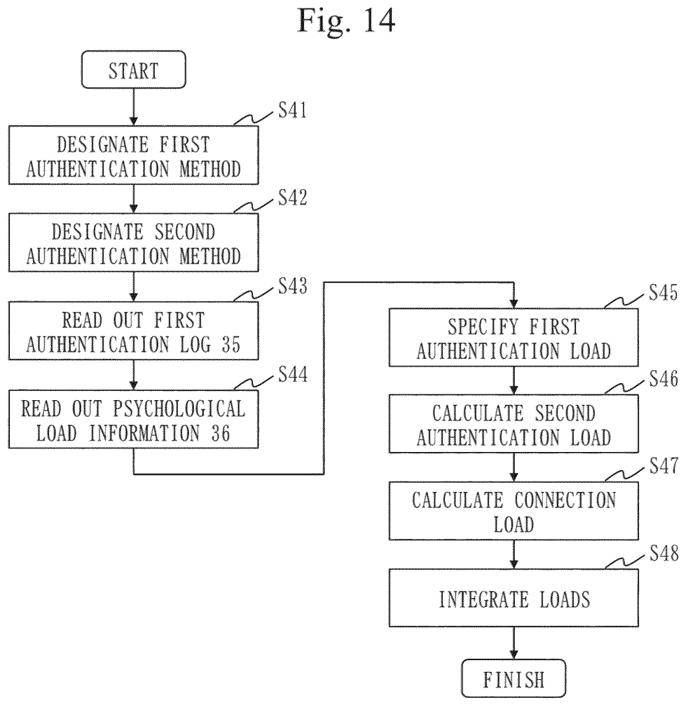

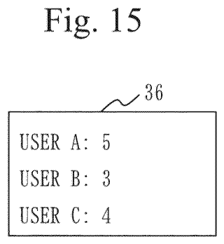

Description will be made on an operation of the load specification device 10 according to Fourth Embodiment, with reference to FIG. 14 and FIG. 15.

The operation procedure of the load specification device 10 according to Fourth Embodiment corresponds to a load specification method according to Fourth Embodiment. Further, a program to realize the operation of the load specification device 10 according to Fourth Embodiment corresponds to a load specification program according to Fourth Embodiment.

Description will be made on a flow of the operation of the load specification device 10 according to Fourth Embodiment, with reference to FIG. 14.

The process from Step S41 through Step 43 is the same as that from Step S31 through Step S33 of FIG. 11. The process from Step S46 through Step S48 is the same as that of the process from Step S35 through Step S37 of FIG. 11.

### (Step S44: Psychological Readout Process)

The first load specification unit 22 reads out the psychological load information 36 from the storage unit 13.

The psychological load information 36 is a result of evaluation of usability of the first authentication method in five levels, as illustrated in FIG. 15. For example, the psychological load information 36 is an answer obtained through a question as to which of the five levels of “very easy to use (5), -easy to use (4), -normal (3), -difficult to use (2), -very difficult to use (1)” the usability of the first authentication method corresponds to.

### (Step S45: First Load Specification Process)

The first load specification unit 22 specifies a first authentication load being a load of a user performing the first authentication.

In Fourth Embodiment, the first load specification unit 22 specifies the first authentication load from the first authentication log 35 read out in Step S43, and the psychological load information 36 read out in Step S44. The first load specification unit 22 is capable of using an arbitrary method as a method to specify the first authentication load from the first authentication log 35 and the psychological load information 36. As a specific example, it can be considered that the first load specification unit 22 changes a calculation formula of the first authentication load in accordance with the mean value of evaluations of the psychological load information 36. For example, if the mean value of evaluations of the psychological load information is three or larger, the first load specification unit 22 uses Formula 1; if not, the first load specification unit 22 uses Formula 2. Formula 1 is that the first authentication load=(t0+t1+ . . . +tn−1)/n. Formula 2 is that the first authentication load=(t0++1+ . . .+tn−1)/(n×0.9). Herein, each operation time indicated in the first authentication log 35 shall be t0, t1, . . . , tn−1.

In this case, the first load specification unit 22 specifies (t0+t1+t2)/3 as the first authentication load from the first authentication log 35 indicated in FIG. 12, and the psychological load information 36 indicated in FIG. 15. Since the mean value of evaluations is 4 in the psychological load information 36 indicated in FIG. 15, Formula 1 is adopted.

### Effect of Fourth Embodiment

As described above, the load specification device 10 according to Fourth Embodiment, the first authentication load is specified in consideration of psychological load. In this manner, it is possible to specify the first authentication load more consistent with reality.

Further, by using the method described in Third Embodiment in combination with the method described in Second Embodiment, it is possible to specify more realistic values also for the second authentication load and the connection load.

“Unit” in the description above may be replaced with “circuit”, “step”, “procedure”, “process” or “processing circuitry”.

In the above, description has been made on the embodiments and the variations of the present disclosure. Some of these embodiments and variations may be combined and performed. Otherwise, any or some may be partially performed. The present disclosure is not limited to the embodiments and the variations described above, and various modifications can be added as needed.

### REFERENCE SIGNS LIST

10: load specification device; 11: processor; 12: memory unit; 13: storage unit; 14: communication interface; 15: electronic circuit; 21: authentication method designation unit; 22: first load specification unit; 23: second load specification unit; 24: connection load specification unit; 25: load integration unit; 31: authentication load information; 32: connection load information; 33: second calculation method; 34: connection calculation method; 35: first authentication log; 36: psychological load information

1. A load specification device to specify a load of a two-factor authentication in which a first authentication and a second authentication are performed in order, the load specification device comprising
processing circuitry
to specify a first authentication load being a load of a user to perform the first authentication;
to specify a second authentication load being a load of the user to perform the second authentication;
to specify a connection load being a load of the user with respect to an operation to transition from the first authentication to the second authentication, and
to integrate the first authentication load, the second authentication load and the connection load, and specify the load of the two-factor authentication.

2. The load specification device as defined in claim 1, wherein
the processing circuitry accepts designation of a first authentication method being an authentication method used in the first authentication, and a second authentication method being an authentication method used in the second authentication,
specifies a load with respect to the first authentication method accepted, as the first authentication load,
specifies a load with respect to the second authentication method accepted, as the second authentication load, and
specifies the connection load with respect to the operation to transition from the first authentication method to the second authentication method.

3. The load specification device as defined in claim 1, wherein the processing circuitry
specifies the first authentication load by reading out a load corresponding to an authentication method used in the first authentication, from authentication load information in which a load for each authentication method is stored,
specifies the second authentication load by reading out a load corresponding to an authentication method used in the second authentication, from the authentication load information, and
specifies the connection load by reading out a load corresponding to a combination of the authentication method used in the first authentication and the authentication method used in the second authentication, from connection load information in which a load for each combination of authentication methods is stored.

4. The load specification device as defined in claim 1, wherein
the processing circuitry calculates the second authentication load based on the first authentication load, by using a calculation method corresponding to a combination of an authentication method used in the first authentication and an authentication method used in the second authentication.

5. The load specification device as defined in claim 1, wherein
the processing circuitry calculates the connection load based on the first authentication load, by using a calculation method corresponding to a combination of an authentication method used in the first authentication and an authentication method used in the second authentication.

6. The load specification device as defined in claim 4, wherein
the processing circuitry specifies the load specified as the first authentication load.

7. The load specification device as defined in claim 4, wherein the processing circuitry calculates the first authentication load from log data being a result of performing the authentication method used in the first authentication.

8. The load specification device as defined in claim 4, wherein the processing circuitry calculates the first authentication load from psychological information to represent a psychological load of the user when the authentication method used in the first authentication is performed.

9. A load specification method to specify a load of a two-factor authentication in which a first authentication and a second authentication are performed in order, the load specification method comprising:
by a computer, specifying a first authentication load being a load of a user to perform the first authentication;
by a computer, specifying a second authentication load being a load of the user to perform the second authentication;
by a computer, specifying a connection load being a load of the user with respect to an operation to transition from the first authentication to the second authentication, and
by a computer, integrating the first authentication load, the second authentication load and the connection load, and specifying the load of the two-factor authentication.

10. A non-transitory computer readable medium storing a load specification program to specify a load of a two-factor authentication in which a first authentication and a second authentication are performed in order, the load specification program causing a computer to function as a load specification device performing:
a first load specification process to specify a first authentication load being a load of a user to perform the first authentication;
a second load specification process to specify a second authentication load being a load of the user to perform the second authentication;
a connection load specification process to specify a connection load being a load of the user with respect to an operation to transition from the first authentication to the second authentication, and
a load integration process to integrate the first authentication load, the second authentication load and the connection load, and to specify the load of the two-factor authentication.
